(19) United States
(12) Patent Application Publication
(10) Pub. No.: US 2015/0319114 A1
(43) Pub. Date: Nov. 5, 2015

(54) METHOD AND SYSTEM FOR MESSAGE CONVERSATION VIEW CUSTOMIZATION

(71) Applicant: VONAGE NETWORK LLC, Holmdel, NJ (US)

(72) Inventor: Tzahi Efrati, Hoboken, NJ (US)

(73) Assignee: VONAGE NETWORK LLC, Holmdel, NJ (US)

(21) Appl. No.: 14/265,692

(22) Filed: Apr. 30, 2014

(51) Int. Cl. H04L 12/58; G06F 3/0485; H04W 4/14

(52) U.S. Cl. CPC H04L 51/046; H04W 4/14; G06F 3/0485; H04L 51/16

(57) ABSTRACT

A method and apparatus for anchoring and controlling objects in messages across multiple devices are provided herein. The method includes displaying one or more messaging objects in a scrollable portion of a first messaging conversation display screen on a first participant device, the one or more messaging objects comprising at least one message conveyed between the first participant device and at least a second participant device; receiving an instruction to perform a first action on a first messaging object of the one or more messaging objects; performing the first action on the first messaging object; and sending a first object instruction message to at least the second participant device to perform a second action on a second messaging object in a second messaging conversation display screen on the second participant device, the second action associated with the first action and the first messaging object associated with the second messaging object.

### BACKGROUND

1. Field

Embodiments of the present invention generally relate to methods and systems for customizing message conversation views in mobile communications systems, and more particularly, to a method and system for anchoring and controlling objects in message conversation views in messaging applications across multiple devices.

2. Description of the Related Art

A mobile phone user often communicates with one or more other mobile phone users via mobile messaging. Mobile messaging includes, but is not limited to, Short Message Service (SMS) communication services, multimedia messaging service (MMS) communication services, instant messaging, over the top (OTT) chats, and the like. Mobile messaging between two users forms a text message conversation. Mobile messaging enables the exchange of multimedia content, e.g., text, images, videos, and other multimedia objects, in messages sent between mobile devices. Mobile messaging also facilitates group conversations, or multiple-recipient messaging. In group messaging conversations, a message can be sent, or broadcast, to more than one addressee. When an addressee responds, or replies, to the message, the response is broadcast to all addressees/recipients of the message.

Mobile messages are generally referred to as messages herein. Messages on a display of each mobile phone scroll as a conversation progresses. Message scrolling makes room in the display for incoming messages. For example, a user may send a message including an image to one or more participants in the conversation, and continue to send messages thereafter. The image and other messages received, also scroll off the screen to make room for incoming messages. However, the users may wish to maintain a view of the image on the screen while continuing the conversation.

Therefore there exists a need in the art for a method and system for anchoring and controlling objects in message conversation views in messaging applications across multiple devices.

### SUMMARY

A method and system for anchoring and controlling objects in messages across multiple devices are provided herein. In some embodiments, a method for anchoring and controlling objects in messages across multiple devices may include displaying one or more messaging objects in a scrollable portion of a first messaging conversation display screen on a first participant device, wherein the one or more messaging objects comprise at least one message conveyed between the first participant device and at least a second participant device; receiving an instruction to perform a first action on a first messaging object of the one or more messaging objects; performing the first action on the first messaging object; and sending a first object instruction message to at least the second participant device to perform a second action on a second messaging object in a second messaging conversation display screen on the second participant device, wherein the second action is associated with the first action and wherein the first messaging object is associated with the second messaging object.

In some embodiments, a system for anchoring and controlling objects in messages across multiple devices, may include a messaging application configured to: display one or more messaging objects in a scrollable portion of a first messaging conversation display screen on a first participant device, wherein the one or more messaging objects comprise at least one message conveyed between the first participant device and at least a second participant device; receive an instruction to perform a first action on a first messaging object of the one or more messaging objects; perform the first action on the first messaging object; and send a first object instruction message to at least the second participant device to perform a second action on a second messaging object in a second messaging conversation display screen on the second participant device, wherein the second action is associated with the first action and wherein the first messaging object is associated with the second messaging object.

In some embodiments, a computer readable medium for anchoring and controlling objects in messages across multiple devices is disclosed. The computer readable medium comprises instructions that when executed by at least one processor causes the at least one processor to perform the method for anchoring and controlling objects in messages across multiple devices.

Other and further embodiments of the present invention are described below.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 depicts a block diagram of a telecommunication network, according to one or more embodiments of the invention;

FIGS. 2A-2C depict a graphical user interfaces for anchoring and controlling objects in messages across multiple devices, according to one or more embodiments;

FIG. 3 depicts a block diagram of a system for anchoring and controlling objects in messages across multiple devices, according to one or more embodiments;

FIG. 4 depicts a flow diagram of a method for anchoring and controlling objects in messages across multiple devices, according to one or more embodiments of the invention;

FIG. 5 depicts a flow diagram of a method for receiving an instruction to perform an action in a messaging conversation, according to one or more embodiments of the invention; and

FIG. 6 depicts a computer system that can be utilized in various embodiments of the present invention to implement the computer and/or the display, according to one or more embodiments.

To facilitate understanding, identical reference numerals have been used, where possible, to designate identical elements that are common to the figures. The figures are not drawn to scale and may be simplified for clarity. It is contemplated that elements and features of one embodiment may be beneficially incorporated in other embodiments without further recitation.

### DETAILED DESCRIPTION

Embodiments of the present invention generally relate to a method and apparatus for anchoring and controlling objects in messages across multiple devices. More specifically, embodiments of the present invention enable fixing an object in messaging windows of two or more participants in a messaging conversation. As such, for said participants in the conversation, incoming text messages scroll while the fixed object remains in view. Thus, embodiments of the present invention advantageously provide participants in a messaging conversation with a common view such that an object of conversation, for example, an image may remain in view while the conversation progresses. Objects include, but are not limited to, a text message, an image, a video, an interactive map or game, and the like. In addition, embodiments of the present invention allow one or more participants of the conversation to modify, or otherwise interact with, the object; for example, play a first ten seconds of a video. The modification/interaction is mirrored in the messaging windows of all participants in the conversation. Thus, embodiments of the present invention advantageously provide participants in a messaging conversation a common viewing and participation experience with an interactive object included in the message conversation.

Some portions of the detailed description which follow are presented in terms of operations on binary digital signals stored within a memory of a specific apparatus or special purpose computing device or platform. In the context of this particular specification, the term specific apparatus or the like includes a general purpose computer once it is programmed to perform particular functions pursuant to instructions from program software. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

Some exemplary embodiments described below are with respect to a mobile Voice over Internet Protocol (VOIP) telecommunication app. However, one skilled in the art will readily recognize from the following description that any native application may be used in embodiments consistent with the present invention without departing from the principles of the disclosure described herein.

In the following description, the terms VOIP system, VOIP telephony system, IP system and IP telephony system are all intended to refer to a system that connects callers and that delivers data, text and video communications using Internet protocol data communications. Those of ordinary skill in the art will recognize that embodiments of the present invention are not limited to use with IP telephony systems and may also be used in other systems.

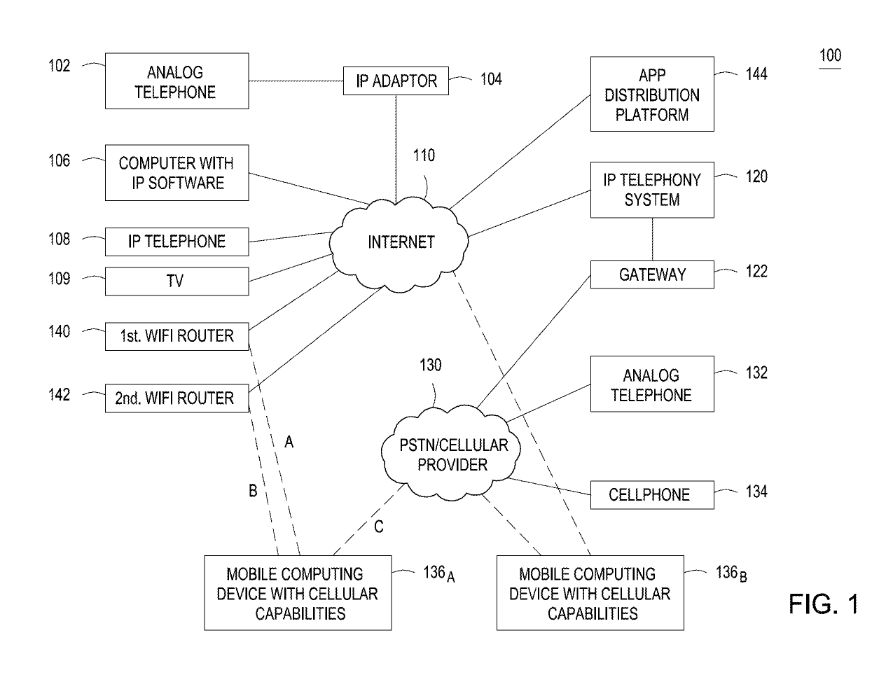

As illustrated in FIG. 1, a communications environment 100 is provided to facilitate IP enhanced communications. An IP telephony system 120 enables connection of telephone calls between its own customers and other parties via data communications that pass over a data network 110. The data network 110 is commonly the Internet, although the IP telephony system 120 may also make use of private data networks. The IP telephony system 120 is connected to the Internet 110. In addition, the IP telephony system 120 is connected to a publicly switched telephone network (PSTN) 130 via a gateway 122. The PSTN 130 may also be directly coupled to the Internet 110 through one of its own internal gateways (not shown). Thus, communications may pass back and forth between the IP telephony system 120 and the PSTN 130 through the Internet 110 via a gateway maintained within the PSTN 130.

The gateway 122 allows users and devices that are connected to the PSTN 130 to connect with users and devices that are reachable through the IP telephony system 120, and vice versa. In some instances, the gateway 122 would be a part of the IP telephony system 120. In other instances, the gateway 122 could be maintained by a third party.

Customers of the IP telephony system 120 can place and receive telephone calls using an IP telephone 108 that is connected to the Internet 110. Such an IP telephone 108 could be connected to an Internet service provider via a wired connection or via a wireless router. In some instances, the IP telephone 108 could utilize a packet-switched network of a cellular telephone system to access the Internet 110.

Alternatively, a customer could utilize an analog telephone 102 which is connected to the Internet 110 via a telephone adapter 104. The telephone adapter 104 converts analog signals from the telephone 102 into data signals that pass over the Internet 110, and vice versa. Analog telephone devices include but are not limited to standard telephones and document imaging devices such as facsimile machines. A configuration using a telephone adapter 104 is common where the analog telephone 102 is located in a residence or business. Other configurations are also possible where multiple analog telephones share access through the same IP adaptor. In those situations, all analog telephones could share the same telephone number, or multiple communication lines (e.g., additional telephone numbers) may provisioned by the IP telephony system 120.

In addition, a customer could utilize a soft-phone client running on a computer 106 or a television 109 to place and receive IP based telephone calls, and to access other IP telephony systems (not shown). The computer 106 may be a personal computer (PC), a tablet device, a gaming system, and the like. In some instances, the soft-phone client could be assigned its own telephone number. In other instances, the soft-phone client could be associated with a telephone number that is also assigned to an IP telephone 108, or to a telephone adaptor 104 that is connected to one or more analog telephones 102.

Users of the IP telephony system 120 are able to access the service from virtually any location where they can connect to the Internet 110. Thus, a customer could register with an IP telephony system provider in the U.S., and that customer could then use an IP telephone 108 located in a country outside the U.S. to access the services. Likewise, the customer could also utilize a computer outside the U.S. that is running a soft-phone client to access the IP telephony system 120.

A third party using an analog telephone 132 which is connected to the PSTN 130 may call a customer of the IP telephony system 120. In this instance, the call is initially connected from the analog telephone 132 to the PSTN 130, and then from the PSTN 130, through the gateway 122 to the IP telephony system 120. The IP telephony system 120 then routes the call to the customer's IP telephony device. A third party using a cellular telephone 134 could also place a call to an IP telephony system customer, and the connection would be established in a similar manner, although the first link would involve communications between the cellular telephone 134 and a cellular telephone network. For purposes of this explanation, the cellular telephone network is considered part of the PSTN 130.

In the following description, references will be made to an “IP telephony device.” This term is used to refer to any type of device which is capable of interacting with an IP telephony system to complete an audio or video telephone call or to send and receive text messages, and other forms of communications. An IP telephony device could be an IP telephone, a computer running IP telephony software, a telephone adapter which is itself connected to a normal analog telephone, or some other type of device capable of communicating via data packets. An IP telephony device could also be a cellular telephone or a portable computing device that runs a software application that enables the device to act as an IP telephone. Thus, a single device might be capable of operating as both a cellular telephone that can facilitate voice based session calls, and an IP telephone that can facilitate data based session calls.

The following description will also refer to a mobile telephony device. The term “mobile telephony device” is intended to encompass multiple different types of devices. In some instances, a mobile telephony device could be a cellular telephone. In other instances, a mobile telephony device may be a mobile computing device, such as the APPLE IPHONE, that includes both cellular telephone capabilities and a wireless data transceiver that can establish a wireless data connection to a data network. Such a mobile computing device could run appropriate application software to conduct VoIP telephone calls via a wireless data connection. Thus, a mobile computing device, such as an APPLE IPHONE, a RIM BLACKBERRY or a comparable device running GOOGLE ANDROID operating system could be a mobile telephony device.

In still other instances, a mobile telephony device may be a device that is not traditionally used as a telephony device, but which includes a wireless data transceiver that can establish a wireless data connection to a data network. Examples of such devices include the APPLE IPOD TOUCH and the IPAD. Such a device may act as a mobile telephony device once it is configured with appropriate application software.

FIG. 1 illustrates that a mobile computing device with cellular capabilities 136_{A} (e.g., a smartphone) is capable of establishing a first wireless data connection A with a first wireless access point 140, such as a WiFi or WiMax router. The first wireless access point 140 is coupled to the Internet 110. Thus, the mobile computing device 136_{A} can establish a VOIP telephone call with the IP telephony system 120 via a path through the Internet 110 and the first wireless access point 140.

FIG. 1 also illustrates that the mobile computing device 136_{A} can establish a second wireless data connection B with a second wireless access point 142 that is also coupled to the Internet 110. Further, the mobile computing device 136_{A} can establish either a third wireless data connection C via a packet-switch network provided by a cellular service provider 130 using its cellular telephone capabilities, or establish a voice based session telephone call via a circuit-switched network provided by a cellular service provider 130. The mobile computing device 136_{A} could also establish a VoIP telephone call with the IP telephony system 120 via the second wireless connection B or the third wireless connection C.

Although not illustrated in FIG. 1, the mobile computing device 136_{A} may be capable of establishing a wireless data connection to a data network, such as the Internet 110, via alternate means. For example, the mobile computing device 136_{A} might link to some other type of wireless interface using an alternate communication protocol, such as the WIMAX standard.

Similarly, mobile computing device with cellular capabilities 136_{B} may also be coupled to internet 110 and/or cellular service provider 130. In some embodiments, mobile computing device 136_{B} may be connected to internet 110 via a WIFI or WIMAX connection, and the like, and can also establish a VOIP telephone calls with the IP telephony system 120 similar to mobile computing device 136_{A}. In embodiments of the present invention, communications environment 100 may be used to establish voice based or data based telecommunications sessions between mobile computing device 136_{A} and mobile computing device 136_{B}, depending on various criteria associated with each of the mobile computing devices, as will be described below in more detail.

In the embodiments described above, a device may act as a mobile telephony device once it is configured with appropriate application software that may be downloaded from an app distribution platform 144. For example, mobile computing device 136_{A} may download a VOIP mobile app from app distribution platform 144 and install the VOIP mobile app locally making the app a native application running on mobile computing device 136_{A}.

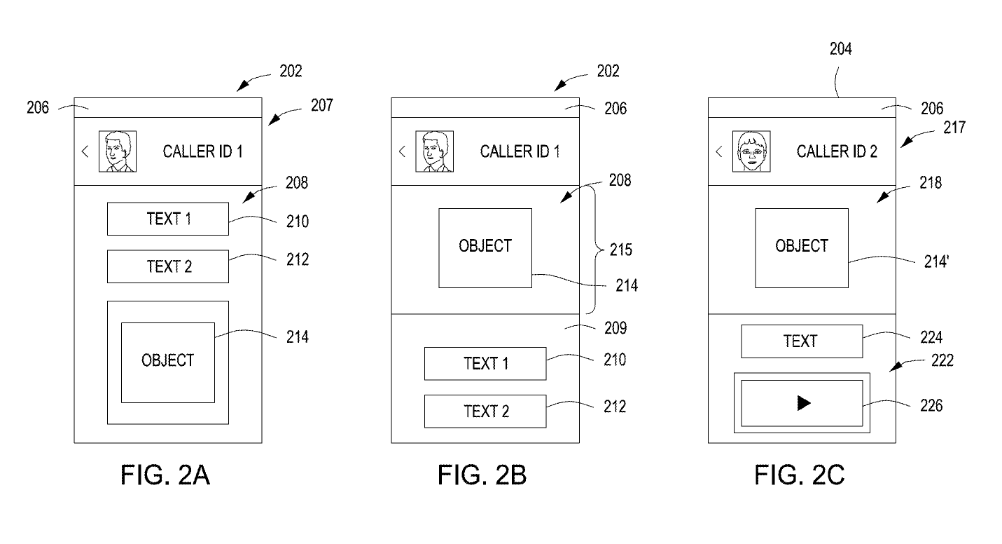

FIGS. 2A-2C illustrate graphical user interfaces for anchoring and controlling objects in message conversation views across multiple devices, according to one or more embodiments. In some embodiments, as shown in FIG. 2A-2C, user devices 202, 204 (such as, for example, mobile computing devices 136_{A}, 136_{B}) may exchange messages in an SMS or MMS messaging conversation via messaging applications installed on each device.

FIG. 2A depicts user device 202 which includes a display 206. The display 206 of the user device 202 displays a messaging pane 208 of a message application 207 installed on device 202. In some embodiments, the message application 207 may be a standalone over-the-top (OTT) application installed on device 202, or a feature/module of an OTT telecommunication app that supports messaging (e.g., a VoIP mobile telecommunication app). The messaging pane 208 includes text messages 210, 212, and an object 214. The object 214 may be a text, an image, a video, or any object that may be transmitted in the conversation. As the conversation progresses, the text messages 210, 212, as well as the object 214 scroll off the screen in order to make room in the messaging pane 208 for new messages.

In embodiments consistent with the present invention a user of user device 202 selects an object 214 in the messaging pane 208 to be anchored to a location within messaging pane 208 on the display 206 of user device 202 such that object 214 remains visible and does not scroll as new messages are sent and/or received (i.e., the location of object 214 is fixed to a non-scrollable portion of the messaging pane 208). In some embodiments, when the location of object 214 is fixed on the display 206 of device 202, a corresponding object location is also fixed within messaging pane 218 on the display 216 of user device 204. In some embodiments, when the object 214 is selected (e.g., pressed, swiped, and the like), the object 214 is automatically fixed to a position within messaging pane 208 of messaging application 207. In other embodiments, selecting the object 214 causes a selectable menu option to be displayed. For example, when a user presses object 214, a “fix object to display” menu item/icon may be displayed on device 202. When the “fix object to display” menu item/icon is selected, the object 214 is fixed to a position within messaging pane 208 of messaging application 207. The position to which the object is anchored/fixed to may be configurable by the user.

As shown in FIG. 2B, in some embodiments, the position to which the object is anchored/fixed in a non-scrollable fixed object pane 215 of the messaging conversation pane 208. All new messages sent and received would continue to scroll in a reduced scrollable message pane 209. In some embodiments, the size of the anchored object 214 is configurable or adjustable by the user. In some embodiments, the size and position of non-scrollable fixed object pane 215 area may be defined (e.g., by default and/or set by the user). In some embodiments, the object 214 is automatically positioned (e.g., centered) and/or adjusted is size/shape such that it may fit within the non-scrollable fixed object pane 215.

In some embodiments, when object 214 is anchored to a position within messaging pane 208 as described above, an object instruction message is generated by messaging application 207 that includes the object 214, or information that identifies the object 214, for example an object identifier, and instructions to anchor the object 214, within a fixed object pane 218 of messaging application 217 on the display 216. The object instruction message is transmitted by messaging application 207 via a network to a service provider's server, which in turn, forwards the object instruction message to the user device 204. It is generally understood in the art that forwarding a message, for example, may include generating and sending a new message based on the received message and not literally forwarding the exact message received. In some embodiments, the object instruction message may be an SMS or MMS message with customized header information that includes the object instructions. In some embodiments, the object instruction message may use a proprietary messaging protocol, such as a Session Initiation Protocol (SIP) message, or use a standard protocol, such as an Extensible Messaging and Presence Protocol (XMPP) message. If the conversation is a group conversation that includes more than two participants, the message is transmitted to user device(s) of each of the participants in the conversation.

FIG. 2C depicts the display 216 of user device 204 after the object 214′ is fixed on the display 216. The user device 204 includes a messaging application that receives the object instruction message. The messaging application parses the object instruction message in order to identify the corresponding object via the object identifier. The messaging application then anchors the object accordingly. The object 214′ on device 204 is the corresponding object 214 on device 202 (i.e., a corresponding text message, image, video, etc. anchored in the display on each participant device). The user device 204 includes a fixed object pane 218 and a reduced messaging pane 222. In some embodiments, the fixed object 214′ is centered in the fixed object pane 218. In the reduced messaging pane 218, additional messages (e.g., text 224 and video 226) scroll to make room in the reduced message pane 218 for incoming messages. As incoming messages arrive and outgoing messages are sent, the fixed object 214′ in the object pane 218 remains in view. Advantageously, participants in a conversation may anchor, for example, an image that is the subject of a conversation. As the participants continue to text commentary regarding the image, the image remains in view (e.g., object 214/214′), while other messages continue to scroll in the reduced messaging panes 209, 222.

In some embodiments, a participant may modify the fixed object 214/214′ by performing an action. In one example, the participant of user device 204 selects the fixed object 214′ to be “un-fixed”, or otherwise removed from the fixed object pane 218 and allowed to scroll. In another example, the participant of user device 204 selects a new object, for example the video 226 to fix to the displays 206, 216 of the devices of the participants in the conversation. The participant presses and slides the participant's finger across the video 226, causing the video 226 to be selected and fixed on the displays 206 and 216 as described above. In some embodiments, a participant may perform an action on the fixed object 214′ locally. For example, the participant of user device 204 can “un-fix” the object 214′ locally, such that the “un-fix” action is performed on the display 216 of user device 204, but the fixed object 214 remains fixed on the display 206 of the device 202.

In some embodiments, users may interact with objects in the message conversation. The interactive objects and the results of any interaction may be displayed on each participant's device such that every participant may similarly experience the interactive object. For example, after the video 226 is anchored in the fixed object pane 218, a user of device 204 plays, for example, ten seconds of the video 226. An object instruction message is generated by messaging application 217 that includes the object identifier that identifies the video object and an instruction to perform a same or similar action on the display 206 that was performed on display 216 (e.g., play ten seconds of the video 226). In some embodiments, the action is adapted for the display 206. For example, tens seconds of the video 226 are played, however the video 226 is displayed in a smaller size to accommodate a size of the display 206 of the device 202. The object instruction message is transmitted by messaging application 217 via a network to the service provider's server and ultimately to display 206 of the user device 202. When the object instruction message is received by messaging application 207 on user device 202, the instruction causes the action that was performed on the video 226 to be performed on the display 206 of the user device 202. In the present example, the first ten seconds of the video is played on the user device 202. Participants may keep an object in view for as long as the participants choose. Modifications to the anchored object by a participant are reflected on the displays of one or more participants in a conversation.

In some embodiments, the anchored object may be an object that updates in real-time, for example, a navigation object, such as a real-time GPS tracker that maintains a participant's location on the displays of all participants in the conversation. The anchored object may be an RSVP object, such as an invitation, for example, that requires a response. The object may be an audio object, for example, a voice message or a song. The object may include a plurality of image messages that when fixed, appear as a single animated image. In some embodiments, the fixed object is an interactive game, wherein actions performed in the game by each user are reflected in the displays of all participants. In some embodiments the fixed object is a poll that can be responded to by the participants in the conversation, while text messaging continues in the messaging pane. In such embodiments, signaling includes a message identifier of the anchored object an action to perform on the anchored object. For example, if the fixed object is a map for the GPS tracker, the action may be to change map coordinates. If the fixed object is the poll, the action may be to add +1 to a given answer to the poll. If the object is the interactive game, such as a chess game, the action may be to move a chess piece to a specific location. In some embodiments, the message object encapsulates the fixed object, for example, a game. In such embodiments, the action that is to be performed within the anchored object is conveyed as a part of the object's protocol. For example, if the object is a web page, the signaling includes a message identifier, a time of a change in the object, and an inner instruction message for the web view, where the message includes HTML tags.

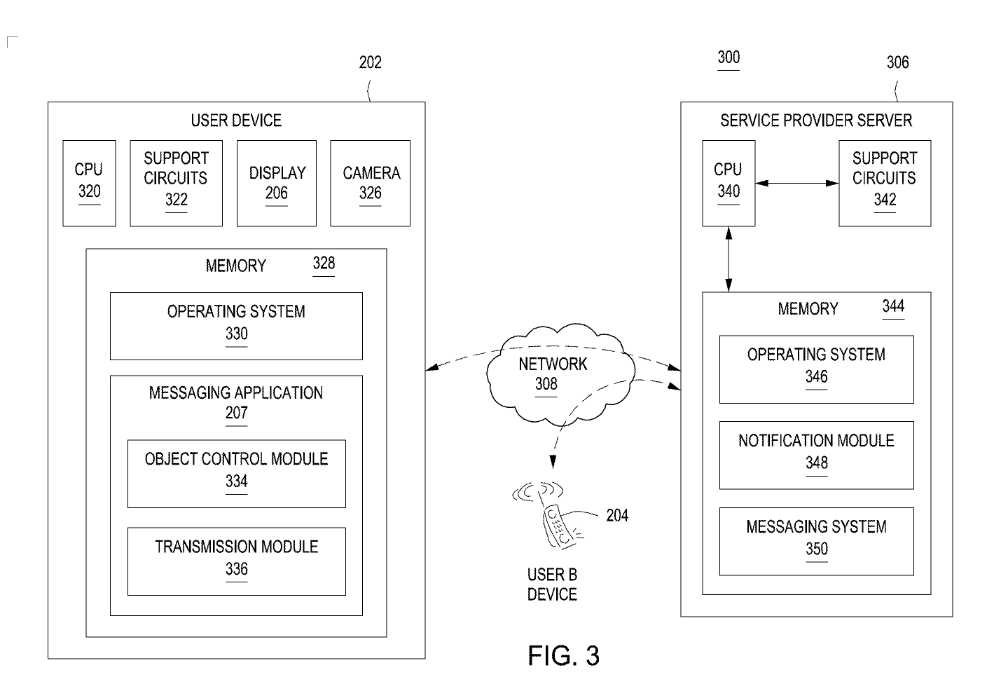

FIG. 3 depicts a block diagram of a system 300 for anchoring and controlling objects in message conversation views across multiple devices, according to one or more embodiments. The system 300 includes at least one telecommunication service provider server 306 that can provide telecommunication services to a plurality of end-user devices (e.g., such as User A device 202 and User B device 204) via one or more networks 308. Devices 202 and 204 may include a computer with IP software 106, IP telephone 108, and/or mobile computing device with cellular capabilities 136A, 136B, and the like, as shown in FIG. 1. The telecommunication service provider server 306 may include IP telephone system 120 or PSTN/cellular provider 130.

Each user device (e.g., User A device 202 and User B device 204) comprises a Central Processing Unit (CPU) 320, support circuits 322, display 206, a camera 326, and a memory 328. The CPU 320 may comprise one or more commercially available microprocessors or microcontrollers that facilitate data processing and storage. The various support circuits 322 facilitate the operation of the CPU 320 and include one or more clock circuits, power supplies, cache, input/output circuits, and the like. The memory 328 comprises at least one of Read Only Memory (ROM), Random Access Memory (RAM), disk drive storage, optical storage, removable storage and/or the like. In some embodiments, the memory 328 comprises an operating system 330 and a messaging application 207. The messaging application 207 may include an object control module 334 and a transmission module 336. In some embodiments, the messaging application 207 may be an OTT telecommunication application as described above.

The operating system (OS) 330 generally manages various computer resources (e.g., network resources, file processors, and/or the like). The operating system 330 is configured to execute operations on one or more hardware and/or software modules, such as Network Interface Cards (NICs), hard disks, virtualization layers, firewalls and/or the like. Examples of the operating system 330 may include, but are not limited to, LINUX, MAC OSX, BSD, UNIX, MICROSOFT WINDOWS, IOS, ANDROID and the like.

The telecommunication service provider server 306 may include a Central Processing Unit (CPU) 340, support circuits 342, and memory 344. The CPU 340 may comprise one or more commercially available microprocessors or microcontrollers that facilitate data processing and storage. The various support circuits 342 facilitate the operation of the CPU 340 and include one or more clock circuits, power supplies, cache, input/output circuits, and the like. The memory 344 comprises at least one of Read Only Memory (ROM), Random Access Memory (RAM), disk drive storage, optical storage, removable storage and/or the like. The memory 344 includes an operating system 346, a notification module 348, and a messaging system 350. The messaging system 350 may be any system that facilitates the sending and receiving of SMS and MMS message, OTT messaging app messages, and the like.

The operating system 346 generally manages various computer resources (e.g., network resources, file processors, and/or the like). The operating system 346 is configured to execute operations on one or more hardware and/or software modules, such as Network Interface Cards (NICs), hard disks, virtualization layers, firewalls and/or the like. Examples of the operating system 346 may include, but are not limited to, LINUX, MAC OSX, BSD, UNIX, MICROSOFT WINDOWS, IOS, ANDROID and the like.

The networks 308 comprise one or more communication systems that connect computers by wire, cable, fiber optic and/or wireless link facilitated by various types of well-known network elements, such as hubs, switches, routers, and the like. The networks 308 may include an Internet Protocol (IP) network 110, a public switched telephone network (PSTN) 130, or other mobile communication networks, and may employ various well-known protocols to communicate information amongst the network resources.

When a user of user device 202 selects an object to fix in a messaging conversation, the object control module 334 generates a message that includes at least an object identifier of the object to be fixed, and instructions to fix the object to the display 206 of each user device 202, 204 in the messaging conversation. The transmission module 336 sends the message to the service provider server 306. The notification module 348 may use a conversation identifier to identify in which messaging conversation the object is to be fixed. The messaging system 350 transmits the message to a user device 202, 204 of each participant in the identified messaging conversation.

The messaging application 207 on each user device 202, 204 parses the message received from the notification module 348 in order to identify the object on which the action is to be performed. The messaging application 207 passes the object and instructions to the object control module 334, which then fixes the object to the display 206. Messages in the messaging conversation scroll off the screen to make room for incoming messages, while the fixed object remains in view.

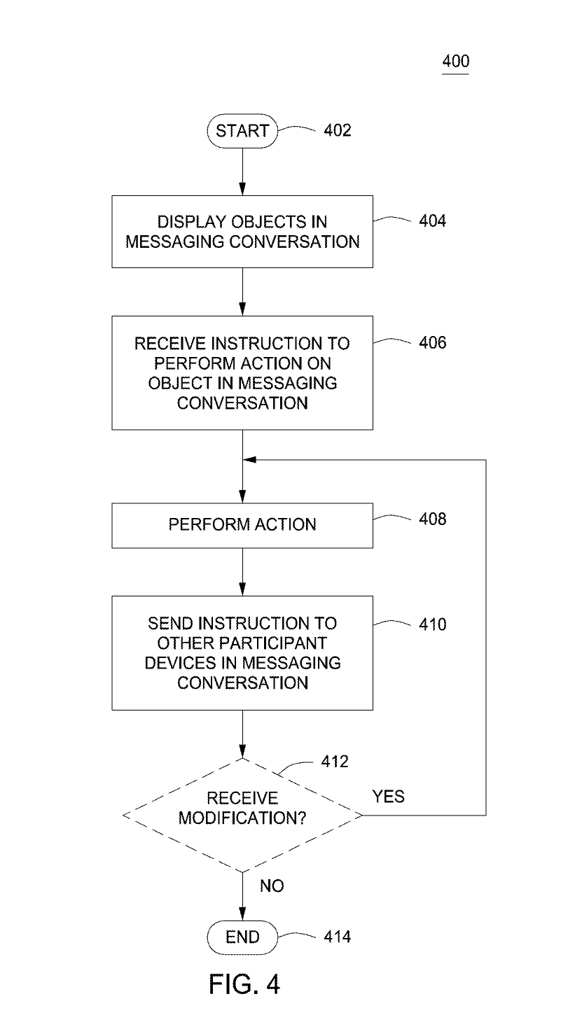

FIG. 4 depicts a flow diagram of a method 400 for anchoring and controlling objects in message conversation views across multiple devices, according to one or more embodiments of the invention. The method 400 begins at step 402 and proceeds to step 404.

At step 404, objects are displayed in a messaging conversation. A messaging conversation is in progress between two or more participants. In some embodiments, a message application, (e.g., messaging application 207) on device 202 displays messages exchanged in an SMS, MMS, or OTT messaging conversation. The messaging conversation may include text messages in addition to other objects, such as a text, an image, a video, or any object that may be transmitted in the messaging conversation. As the messaging conversation progresses, the objects scroll off the screen in order to make room to display incoming messages.

The method 400 proceeds to step 406. At step 406, an instruction is received to perform an action on an object in the messaging conversation. For example, the instruction may be an instruction to anchor an object in the messaging conversation. If an object is already anchored in the messaging conversation, the instruction may be to modify the anchored object. In some embodiments, the instruction may be received in response to a selection of an object in the message conversation. For example, when the object is selected, a menu option/icon is displayed, for example, an “anchor object to display” icon. In some embodiments, the instruction may be received when the object is selected and, using a sliding action, such as a finger swipe, the object is slid to the top of the screen. The instruction identifies the selected object as well as the action to be performed on the selected object.

The method 400 proceeds to step 408, where the action is performed on the selected object on the display of the user device where the action was initiated. If the instruction is to anchor the selected object, the display of the user device is partitioned, such that a location of the selected object is fixed in a non-scrollable pane of the messaging conversation display screen. The non-scrollable pane of the message conversation display screen holds the anchored object in view, while a scrollable pane of the message conversation display screen displays incoming messages of the messaging conversation. If the instruction is to modify the selected object, for example, to enlarge an image, play a video, and the like, the action is performed on the selected object per the instruction. The method 400 proceeds to step 410.

At step 410, the instruction is sent to other participant devices of the messaging conversation. In some embodiments, the instruction is sent to less than all of the other participant devices of the messaging conversation. A user may select a subset of participants in the messaging conversation to view the fixed object. In some embodiments, the subset of participants is identified based on other logic, for example, a device type of a given participant. For example, the subset of participants who are sent the instruction may exclude participants with small-screen devices that are not favorable to displaying fixed objects. An object instruction message is generated that identifies the selected object, using, for example, an object identifier. In addition, the object instruction message may identify an action to be performed on the identified object. For example, an image may be identified with an action to increase the zoom on the image by a percentage. A video may be identified with an action to playback a first ten seconds of the video. Any action performed on the identified object is included in the object instruction message. The message includes at least a list of participant device identifiers, the selected object, and the action to perform on the object.

The method 400 optionally proceeds to step 412, where the method 400 receives a request to modify the fixed object. Modifications include, but are not limited to, selecting a new object to replace the fixed/anchored object, “un-fixing” the fixed object, modifying or interacting with the object, such as advancing a video to a user determined location, and the like. If the method 400 receives a request to modify the fixed image, the method 400 proceeds to step 408. If no request to modify the anchored object is received, the method 400 proceeds to step 414 and ends.

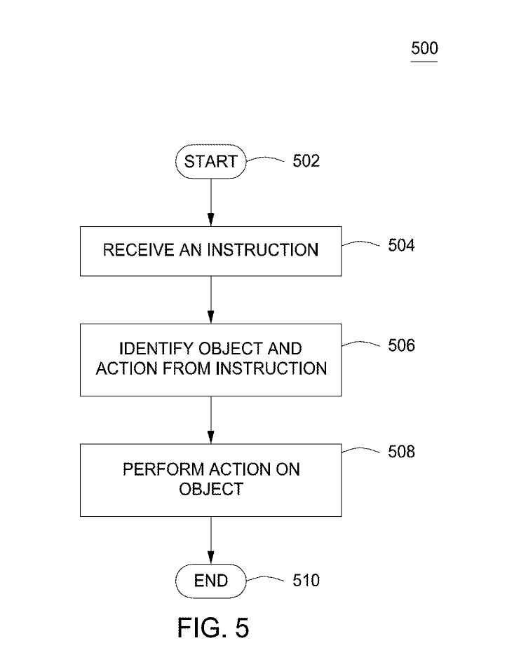

FIG. 5 depicts a flow diagram of a method 500 for receiving an instruction to perform an action in a messaging conversation, according to one or more embodiments of the invention. The method 500 is initiated when a participant in a messaging conversation performs an action on an object in the messaging conversation. The action is to be mirrored in the messaging conversation display screen of the device where the instruction is received. The method 500 starts at step 502 and proceeds to step 504.

At step 504, an instruction is received on a user device of a participant in the messaging conversation. The messaging conversation may include SMS, MMS, or OTT messaging app messages. As a messaging conversation progresses, messages are displayed in a messaging conversation display screen of the participant. In some embodiments, the instruction may be received by a message application (e.g., messaging application 207) on device 202. The instruction identifies an action that was performed on an object in the messaging conversation of another participant. The instruction includes information that identifies the object in the messaging conversation on which the action was performed. The instruction also includes an action that is to be performed on the object. For example, the instruction may be to anchor a particular image in the messaging conversation.

The method 500 proceeds to step 506. At step 506, an object in the messaging conversation is identified from the instruction as well as an action to perform on the object. The instruction is parsed in order to extract an object identifier in addition to an action to be performed on the object. For example, the other participant who initiated the instruction selected a video from the messaging conversation, and an action to anchor the video. The instruction includes an object identifier to identify the video. The action is to anchor the video in the messaging conversation. In another example, if the other user had already anchored the video, the other participant may have played the video on the other participant's device. In such an example, the action may be to playback a first ten seconds of the video.

The method 500 proceeds to step 508, where the identified action is performed on the identified object. If the action is to anchor the object, the messaging conversation display screen is partitioned to include a non-scrollable pane in which to display the identified object, and a scrollable pane in which to display incoming and outgoing messaging objects. A location of the identified object is then fixed in the non-scrollable pane.

If an object is already fixed in the non-scrollable pane, the instruction may include an action to unfix the object. In order to unfix an object, the partitioning of the messaging conversation display screen is removed, and the entire display screen reverts to a scrollable pane.

If the instruction identifies an object that is not fixed in the non-scrollable pane, the object is anchored in the non-scrollable pane as described above and the action performed. If an object was already anchored in the non-scrollable pane, the anchored object is replaced with the identified object.

If the instruction identifies the object that is already anchored in the non-scrollable pane, the action is performed on the object in the non-scrollable pane. For example, if the object is an image, the identified action may be to increase the zoom level of the image by an identified percentage. The zoom level of the image is increased in the non-scrollable pane by the identified percentage. If the object is a video, the identified action may be to playback an identified number of seconds of the video. In such case, the video is played in the non-scrollable pane.

The method 500 proceeds to step 510 and ends.

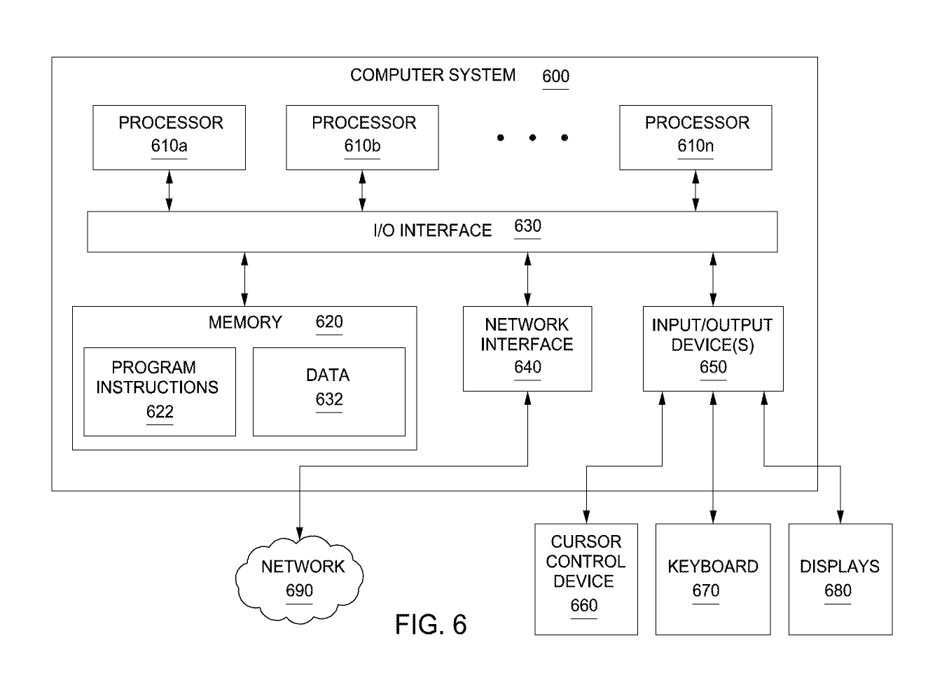

FIG. 6 depicts a computer system 600 that can be utilized in various embodiments of the present invention to implement the computer and/or the display, according to one or more embodiments.

Various embodiments of method and apparatus for organizing, displaying and accessing contacts in a contact list, as described herein, may be executed on one or more computer systems, which may interact with various other devices. One such computer system is computer system 600 illustrated by FIG. 6, which may in various embodiments implement any of the elements or functionality illustrated in FIGS. 1-5. In various embodiments, computer system 600 may be configured to implement methods described above. The computer system 600 may be used to implement any other system, device, element, functionality or method of the above-described embodiments. In the illustrated embodiments, computer system 600 may be configured to implement the method 400 as processor-executable executable program instructions 622 (e.g., program instructions executable by processor(s) 610) in various embodiments.

In the illustrated embodiment, computer system 600 includes one or more processors 610a-610n coupled to a system memory 620 via an input/output (I/O) interface 630. Computer system 600 further includes a network interface 640 coupled to I/O interface 630, and one or more input/output devices 650, such as cursor control device 660, keyboard 670, and display(s) 680. In various embodiments, any of the components may be utilized by the system to receive user input described above. In various embodiments, a user interface may be generated and displayed on display 680. In some cases, it is contemplated that embodiments may be implemented using a single instance of computer system 600, while in other embodiments multiple such systems, or multiple nodes making up computer system 600, may be configured to host different portions or instances of various embodiments. For example, in one embodiment some elements may be implemented via one or more nodes of computer system 600 that are distinct from those nodes implementing other elements. In another example, multiple nodes may implement computer system 600 in a distributed manner.

In different embodiments, computer system 600 may be any of various types of devices, including, but not limited to, a personal computer system, desktop computer, laptop, notebook, or netbook computer, mainframe computer system, handheld computer, workstation, network computer, a camera, a set top box, a mobile device, a consumer device, video game console, handheld video game device, application server, storage device, a peripheral device such as a switch, modem, router, or in general any type of computing or electronic device.

In various embodiments, computer system 600 may be a uniprocessor system including one processor 610, or a multiprocessor system including several processors 610 (e.g., two, four, eight, or another suitable number). Processors 610 may be any suitable processor capable of executing instructions. For example, in various embodiments processors 610 may be general-purpose or embedded processors implementing any of a variety of instruction set architectures (ISAs). In multiprocessor systems, each of processors 610 may commonly, but not necessarily, implement the same ISA.

System memory 620 may be configured to store program instructions 622 and/or data 632 accessible by processor 610. In various embodiments, system memory 620 may be implemented using any suitable memory technology, such as static random access memory (SRAM), synchronous dynamic RAM (SDRAM), nonvolatile/Flash-type memory, or any other type of memory. In the illustrated embodiment, program instructions and data implementing any of the elements of the embodiments described above may be stored within system memory 620. In other embodiments, program instructions and/or data may be received, sent or stored upon different types of computer-accessible media or on similar media separate from system memory 620 or computer system 600.

In one embodiment, I/O interface 630 may be configured to coordinate I/O traffic between processor 610, system memory 620, and any peripheral devices in the device, including network interface 640 or other peripheral interfaces, such as input/output devices 650. In some embodiments, I/O interface 630 may perform any necessary protocol, timing or other data transformations to convert data signals from one component (e.g., system memory 620) into a format suitable for use by another component (e.g., processor 610). In some embodiments, I/O interface 630 may include support for devices attached through various types of peripheral buses, such as a variant of the Peripheral Component Interconnect (PCI) bus standard or the Universal Serial Bus (USB) standard, for example. In some embodiments, the function of I/O interface 630 may be split into two or more separate components, such as a north bridge and a south bridge, for example. Also, in some embodiments some or all of the functionality of I/O interface 630, such as an interface to system memory 620, may be incorporated directly into processor 610.

Network interface 640 may be configured to allow data to be exchanged between computer system 600 and other devices attached to a network (e.g., network 690), such as one or more external systems or between nodes of computer system 600. In various embodiments, network 690 may include one or more networks including but not limited to Local Area Networks (LANs) (e.g., an Ethernet or corporate network), Wide Area Networks (WANs) (e.g., the Internet), wireless data networks, some other electronic data network, or some combination thereof. In various embodiments, network interface 640 may support communication via wired or wireless general data networks, such as any suitable type of Ethernet network, for example; via telecommunications/telephony networks such as analog voice networks or digital fiber communications networks; via storage area networks such as Fiber Channel SANs, or via any other suitable type of network and/or protocol.

Input/output devices 650 may, in some embodiments, include one or more display terminals, keyboards, keypads, touchpads, scanning devices, voice or optical recognition devices, or any other devices suitable for entering or accessing data by one or more computer systems 600. Multiple input/output devices 650 may be present in computer system 600 or may be distributed on various nodes of computer system 600. In some embodiments, similar input/output devices may be separate from computer system 600 and may interact with one or more nodes of computer system 600 through a wired or wireless connection, such as over network interface 640.

In some embodiments, the illustrated computer system may implement any of the operations and methods described above, such as the operations described with respect to FIG. 3 and the methods illustrated by the flowcharts of FIGS. 4 and 5. In other embodiments, different elements and data may be included.

Those skilled in the art will appreciate that computer system 600 is merely illustrative and is not intended to limit the scope of embodiments. In particular, the computer system and devices may include any combination of hardware or software that can perform the indicated functions of various embodiments, including computers, network devices, Internet appliances, PDAs, wireless phones, pagers, and the like. Computer system 600 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 600 may be transmitted to computer system 600 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium or via a communication medium. In general, a computer-accessible medium may include a storage medium or memory medium such as magnetic or optical media, e.g., disk or DVD/CD-ROM, volatile or non-volatile media such as RAM (e.g., SDRAM, DDR, RDRAM, SRAM, and the like), ROM, and the like.

The methods described herein may be implemented in software, hardware, or a combination thereof, in different embodiments. In addition, the order of methods may be changed, and various elements may be added, reordered, combined, omitted or otherwise modified. All examples described herein are presented in a non-limiting manner. Various modifications and changes may be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of embodiments as defined in the claims that follow.

While the foregoing is directed to embodiments of the present invention, other and further embodiments of the invention may be devised without departing from the basic scope thereof, and the scope thereof is determined by the claims that follow.

1. A computer-implemented method for customizing message conversation views across multiple devices, comprising:
displaying one or more messaging objects in a scrollable portion of a first messaging conversation display screen on a first participant device, wherein the one or more messaging objects comprise at least one message conveyed between the first participant device and at least a second participant device;
receiving an instruction to perform a first action on a first messaging object of the one or more messaging objects;
performing the first action on the first messaging object; and
sending a first object instruction message to at least the second participant device to perform a second action on a second messaging object in a second messaging conversation display screen on the second participant device, wherein the second action is associated with the first action and wherein the first messaging object is associated with the second messaging object.

2. The method of claim 1, wherein each of the one or more messaging objects is one of a Short Message Service (SMS) message, a multimedia messaging service (MMS) message, or an Over-the-top (OTT) messaging app message.

3. The method of claim 2, wherein performing the first action comprises fixing a location of the first messaging object to a non-scrollable portion of the first messaging conversation display screen.

4. The method of claim 3, wherein the first object instruction message comprises instructions to fix a location of a second messaging object to a non-scrollable portion of a second messaging conversation display screen on the second participant device.

5. The method of claim 3, wherein fixing the location of the first messaging object includes partitioning the messaging conversation display screen to include a first non-scrollable pane in which to display the first messaging object, and a second scrollable pane in which incoming and outgoing messaging objects are displayed.

6. The method of claim 1, wherein the first object instruction message includes an object identifier associated with at least one of the first messaging object or the second messaging object.

7. The method of claim 2, wherein the first messaging object is an interactive multimedia object comprising one of a text object, a video object, a game object, a map object, a web view object, a poll object, an RSVP object, a navigation object, or an audio object.

8. The method of claim 7, wherein the first object instruction message includes instructions to at least one of change a game status, refresh a web view, highlight coordinates in a navigation object, or flash a text message.

9. The method of claim 2, wherein the first messaging object is a first video object, and wherein the action performed is a play video action, and wherein the first object instruction message comprises instructions to play a corresponding second video object.

10. The method of claim 2, further comprising:
receiving a second object instruction message from one of the participant devices other than the first participant device to perform a third action on the first messaging object; and
performing the third action on the first messaging object.

11. The method of claim 10, wherein the third action is at least one of unfixing a location of the first messaging object or fixing the location of a third messaging object to a non-scrollable portion of the first messaging conversation display screen.

12. A system for anchoring and controlling objects in messages across multiple devices participating in a messaging conversation, comprising:
a messaging application configured to:
display one or more messaging objects in a scrollable portion of a first messaging conversation display screen on a first participant device, wherein the one or more messaging objects comprise at least one message conveyed between the first participant device and at least a second participant device;
receive an instruction to perform a first action on a first messaging object of the one or more messaging objects;
perform the first action on the first messaging object; and
send a first object instruction message to at least the second participant device to perform a second action on a second messaging object in a second messaging conversation display screen on the second participant device, wherein the second action is associated with the first action and wherein the first messaging object is associated with the second messaging object.

13. The system of claim 12, wherein each of the one or more messaging objects is one of a Short Message Service (SMS) message, a multimedia messaging service (MMS) message, or an Over-the-top (OTT) messaging app message.

14. The system of claim 13, wherein performing the first action comprises fixing a location of the first messaging object to a non-scrollable portion of the first messaging conversation display screen, and wherein the first object instruction message comprises instructions to fix a location of a second messaging object to a non-scrollable portion of a second messaging conversation display screen on the second participant device.

15. The system of claim 14, wherein fixing the location of the first messaging object includes partitioning the messaging conversation display screen to include a first non-scrollable pane in which to display the first messaging object, and a second scrollable pane in which incoming and outgoing messaging objects are displayed.

16. The system of claim 12, wherein the first object instruction message includes an object identifier associated with at least one of the first messaging object or the second messaging object.

17. The system of claim 13, wherein the first messaging object is an interactive multimedia object comprising one of a text object, a video object, a game object, a map object, a web view object, a poll object, an RSVP object, a navigation object, or an audio object.

18. The system of claim 17, wherein the first object instruction message includes instructions to at least one of play a corresponding video object, change a game status, refresh a web view, highlight coordinates in a navigation object, or flash a text message.

19. The system of claim 13, further comprising:
receiving a second object instruction message from one of the participant devices other than the first participant device to perform a third action on the first messaging object; and
performing the third action on the first messaging object,
wherein the third action is at least one of unfixing a location of the first messaging object or fixing the location of a third messaging object to a non-scrollable portion of the first messaging conversation display screen.

20. A non-transitory computer readable medium for anchoring and controlling objects in messages across multiple devices, comprising:
displaying one or more messaging objects in a scrollable portion of a first messaging conversation display screen on a first participant device, wherein the one or more messaging objects comprise at least one message conveyed between the first participant device and at least a second participant device;
receiving an instruction to perform a first action on a first messaging object of the one or more messaging objects;
performing the first action on the first messaging object; and
sending a first object instruction message to at least the second participant device to perform a second action on a second messaging object in a second messaging conversation display screen on the second participant device, wherein the second action is associated with the first action and wherein the first messaging object is associated with the second messaging object.
